(19) United States
(12) Patent Application Publication
(10) Pub. No.: US 2005/0192049 A1
(43) Pub. Date: Sep. 1, 2005

(54) Cordless terminal for connection to computer and communication networks and/or information networks

(76) Inventor: Jorge Parera Nunez, Begues (ES)

Correspondence Address: STURM & FIX LLP, 206 SIXTH AVENUE, SUITE 1213, DES MOINES, IA, 50309-4076, US

(21) Appl. No.: 10/661,649

(22) Filed: Sep. 12, 2003

Related U.S. Application Data
(63) Continuation of application No. PCT/ES02/00107, filed on Mar. 11, 2002.

(30) Foreign Application Priority Data
Mar. 13, 2001 (ES) ES 200100576

(51) Int. Cl. H04M 1/00; H04B 1/38

(52) U.S. Cl. 455/556.1; 455/557

(57) ABSTRACT

A cordless terminal for connecting to computer networks and communication and/or information networks, suitable for surfing the Internet and remote handling of e-mail, being comprised of a reduced sized terminal which comprises a motherboard and processor unit, with integrated controlling devices of the peripherals and large storage means for the operating system and user applications. Said terminal comprises of a viewing screen having limited thickness, for example, LCD-TFT type or similar, onto which there is a tactile panel for interaction with the user, being the mobile terminal connected a cordless connection preferably via radio electric or microwave signals, with a fixed support module and/or with remote servers. Said fixed support module has an electrical supply source joined to the electricity network and a modem or similar of telephone connection or cable to a remote server network. Said support is associated to the feeding supply with a charging of the batteries, suitable for the recharging of the terminal feeding batteries when said terminal is at a distance from the support.

### CROSS REFERENCE TO RELATED APPLICATIONS

This application is a continuation application of PCT/ES02/00107 filed Mar. 11, 2002, claiming priority of Spanish Application No. ES 200100576 filed Mar. 13, 2001, which are included in their entirety by reference made hereto.

### BACKGROUND OF THE INVENTION

1. Field of the Invention

The present invention relates to the field of electronic devices, and more particularly to a cordless terminal for connecting to networks.

2. Description of the Related Art

As a result of the present increase that is taking place in telecommunications, the access to global computer communication networks, also known as the Internet system, is becoming more necessary every day. This is not only affecting the business world but also has spread to the domestic and leisure scope.

At the present time, said connection to the Internet is carried out by means of Personal Computers or similar devices being either desktops or laptops. These computers are generally placed in fixed places, on a table or desk and connected by means of an electrical cable to the alternating current supply net and by means of another cable to the telephone or communications network, in addition to the connections to other peripherals such as printers, scanners, etc. This poses the problem that said computer systems can not easily be carried to the place where a constant communication is desired. There is the possibility of using laptop computers (the notebook type) connected to mobile telephones, but this solution is expensive, complicated to handle and cannot be connected to other peripheral devices.

### BRIEF SUMMARY OF THE INVENTION

The aim of the present Patent Invention application is to register a cordless terminal for connecting to computer networks and communication and/or information networks that includes significant innovations and advantages compared to the present terminals and computers that are used for similar purposes for the connection to information networks and especially to the Internet.

More specifically the new invention consists of a reduced sized terminal that is based on webpc architecture (a computer that is basically dependent on the applications and resources resident in one or more remote servers) and which allows a direct Internet connection for its more general uses, surfing the net, handling e-mail and consulting databases amongst many others. This terminal is characterised in that it is made up of portable and cordless module that can operate away from the base or support without losing data connection, being located in the base or support the energy supply source and the direct connection to the communication nets via asynchronous protocol, as for example connection by basic telephone network, GSM mobile telephone network, ADSL network or other alternative data transmission system, such as transmission via the electrical supply system (PLC).

### BRIEF DESCRIPTION OF THE SEVERAL VIEWS OF THE DRAWINGS

FIG. 1. Showing a perspective view of the preferred physical make up.

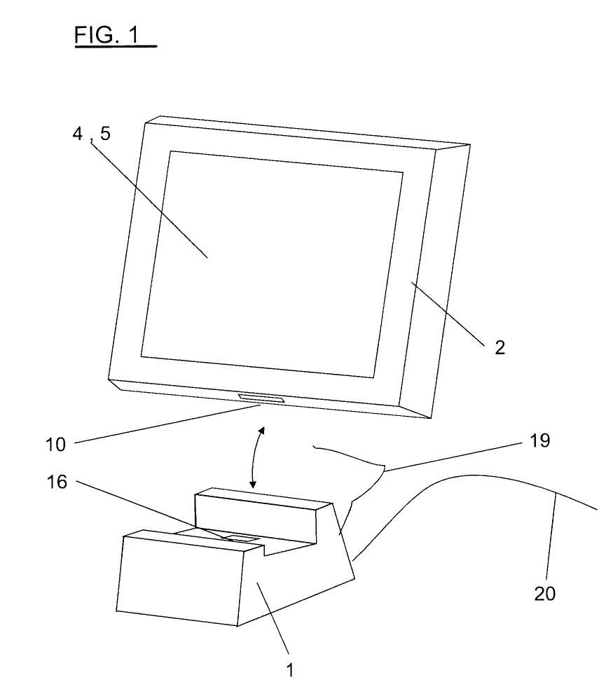

FIG. 2. Showing a functional block scheme.

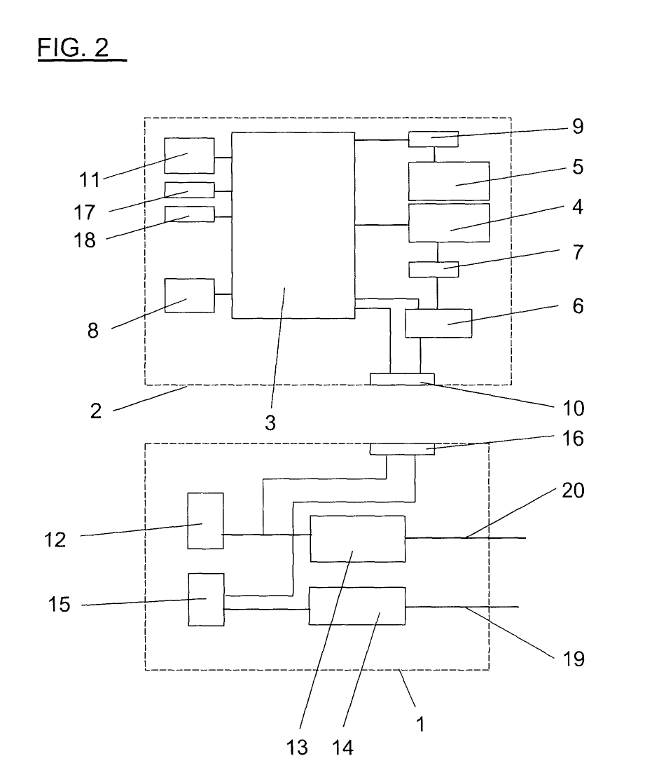

### DETAILED DESCRIPTION OF THE INVENTION

The cordless terminal for connecting to computer and communication networks and/or information networks which is the object of this present patent application is characterised in that it physically comprises a reduced size and totally independent mobile terminal, which is easily carried by a person and allows its operation in any situation. In addition, the construction of said terminal has to have a very low cost and intuitive use even for people who are not experts in information technology and the handling of computers.

In order to do this, the use of a reduced sized computer-terminal has been thought up which is made up of two modules. The main module is made up of a reduced size motherboard with the necessary add-ons for its set up and handling, being comprised of a liquid crystal screen for the viewing and a tactile keyboard for its control, all being supplied by batteries. Said module is connected to a support base using ‘wireless’ transmission with a maximum range for its freedom of movement preferably equivalent to 50 metres and immune from interference and obstacles, such as radio frequency or microwave transmission. Said support is the module that is directly connected to the electricity supply network and to a modem or to the communications line to the outside. In addition, the support module has the functions of charging the batteries of the mobile terminal and the possibility of concentrating the connections with the peripherals, such as printer, scanner or any other. Said support module and the mobile terminal are always connected to each other by the cordless network, in such a way that the terminal always has access to the Internet by using the cordless protocol or to the peripherals connected to the support module. However, the mobile terminal can be left on the support module for battery recharge and direct connection by cable to the peripherals and the communications associated to the support module, as for example, a greater speed USB (Universal Serial Bus) connection. The external shape of the mobile terminal will be preferably similar to a small book or similar, having a flat shape and whose screen occupies the greater part of one of its main sides.

Functionally the mobile terminal (2) comprises a computer motherboard (3) with a processor, working memory and the majority of the peripheral controllers incorporated, especially the video controllers for its connection to a TV or similar, sound and large storage devices. The motherboard (3) used will be preferably a ‘Geode’ board from the company National Semiconductor, which has a small size and reduced consumption offering sufficient features for the working of the mobile terminal (1), including standard connections of various peripherals for their eventual use. The working RAM memory (Random Access Memory) will be large enough for the applications that would be used.

The mobile terminal (2) is fed by means of rechargeable batteries (6), selecting as preferent elements batteries using the NiHM (Nickel Metal Hydride) technology due to their high-energy capacity and recharging possibilities.

In respect of the large storage device, the use of a non-volatile solid state memory disk (Disk On Chip) (11) has been chosen for the storage of the operating system and the basic operating applications, such as the browser for the hypertext pages, the e-mail client application and the diagnostic and handling utilities for the video and sound multi-media capabilities that are fitted to the motherboard (3). Said DOC disk (11), as a result of not having any mechanical parts, is stronger and has a lower consumption.

The motherboard (3) is connected to a viewing monitor; by choice, the monitor will be a liquid crystal (LCD) type monitor (4) that can be directly connected to the graphic system of the motherboard (3). This liquid crystal screen (4) is preferably of the TFT (Thin Film Transistor) type, since said motherboard (3) is prepared for direct connection to it.

The TFT liquid crystal screen (4) needs a backlighting source, supplied by a low consumption fluorescent lamp. Said fluorescent lamp is fed by a high-tension electric inverter (7) connected directly to the batteries (6).

The presence of a tactile panel (5) or pressure sensitive pad has been envisaged on the LCD screen (4) for the introduction of the commands. In this way, the entry of commands via said tactile panel (5) is intuitive; this can be by using graphical icons, insertion point or handwriting recognition. Said panel (5) is by preference the 4-wire resistor type managed by a strong data translation controller (9) that is stable at the time of requiring the movement and positioning of the cursor or pressure point.

The mobile terminal (2) completes its multimedia characteristics with a set of speakers (17) and a microphone (18) connected to the sound inputs and outputs of the controller integrated into the Geode motherboard (3).

The communication between the mobile terminal (2) and the support module (1) will be preferably carried out by radio frequency, using a protocol that works in the high frequency or microwave range. Preferably, the DECT protocol would be used.

The support module (1) preferably comprises a physical structure suitable to locate the mobile terminal (1) when it is not being used, being said terminal (2) activated or deactivated. The support (1) has a connection to the electricity supply (19) network and a stabilised power supply (14) that feeds a battery charger (15) so as to recharge the energy used from the batteries (6) of the terminal (2) during its uncoupled use of said support (1). The stated charger (15) could preferably be of the type MAX712 which comprises a integrated chip (from the company MAXIM) and with monitoring of the state of the NiMH batteries (6) which are fitted into the mobile terminal (2). The data connection to the outside is carried out by a modem (13) with a suitable technology or a connection to a local area network (LAN) or wide area network (WAN). Preferably said modem (13) can be of the conventional technology type that is connectable to a RTB (basic telephone network), ADSL, ISDN (Integrated Services Digital Network), optic fiber technology, specialised communication networks or GSM (Global System Mobile) mobile communications networks.

For the permanent cordless connection between the support module (1) and the mobile terminal (2) the use of two DECT cordless communication modules (8 and 12) has been provided, one of these being installed in the support module (1) and in the mobile terminal (2), respectively. Said modules (8 and 12) have an effective communication radius of up to 50 metres, depending on the manufacturer and their characteristics, an approximate tipical communication speed of 23 kbps (kilobits per second), however, the use of a cordless communication module by means of broadband microwaves, blue tooth technology or similar is not dismissed. As fixed communication connection, said terminal has a USB connector or similar suitable for the direct download of data from the terminal (2) when it is connected on the support module (1). Said fixed connection from the mobile terminal (2) when it is placed on the support module (1) is carried out by means of a common plug (10 and 16) between both, said plug (10 and 16) incorporates the connection between the charger (15) and the batteries (6) and the USB data transfer connection or similar from the modem (13).

In order to complete the description that is going to be made below and with the purpose of helping to give a better understanding of its characteristics, the present descriptive memorandum is accompanied by a set of drawings, which are by way of illustration and not limitative, where the most significant details of the invention are represented.

1-3. (canceled)

4. A cordless terminal for connection to computer and communication networks and/or information networks, made up of a data processor, graphical screen, one or more data input devices and a large storage device, the terminal comprising: a mobile terminal communicated in a cordless and continuous manner with a support module, said support module having a power supply source and an outside data communication connection.

5. The cordless terminal in accordance with claim 4, wherein the mobile terminal is made up of a reduced size motherboard with integrated peripheral controllers, and connected to a flat graphical screen that has a tactile screen superimposed for data entry, with its appropriate controller, wherein the large storage device is comprised of a solid state device without mechanical elements where the operating system is placed, and applications to access to user resources in remote computers.

6. The cordless terminal in accordance with claim 4, wherein the mobile terminal and the support module both have a cordless communication module operatively suitable for a permanent remote communication; and wherein the mobile terminal and the support module have common plugs connecting both when said mobile terminal is placed on the support module comprising the common plugs, a recharging connection of the feeding batteries by means of a smart battery, a charger, and a broad band data connection.

7. The cordless terminal in accordance with claim 5, wherein the mobile terminal and the support module both have a cordless communication module operatively suitable for a permanent remote communication; and wherein the mobile terminal and the support module have common plugs connecting both when said mobile terminal is placed on the support module comprising the common plugs, a recharging connection of the feeding batteries by means of a smart battery, a charger, and a broad band data connection.

8. The cordless terminal in accordance with claim 4, wherein the mobile terminal and support module are communicated in a cordless and continuous manner by transmission of radio electric waves or microwaves.

9. The cordless terminal in accordance with claim 5, wherein the flat graphical screen is a liquid crystal display.
